(19) United States
(12) Patent Application Publication
(10) Pub. No.: US 2013/0014860 A1
(43) Pub. Date: Jan. 17, 2013

(54) Method for manufacturing melt-spinning alloys and apparatus thereof

(71) Applicants: Hongwei Li, Beijing (CN); Dunbo Yu, Beijing (CN); Yang Luo, Beijing (CN); Kuoshe Li, Beijing (CN); Shipeng Li, Beijing (CN); Min Wang, Beijing (CN); Yongqiang Yuan, Beijing (CN)

(72) Inventors: Hongwei Li, Beijing (CN); Dunbo Yu, Beijing (CN); Yang Luo, Beijing (CN); Kuoshe Li, Beijing (CN); Shipeng Li, Beijing (CN); Min Wang, Beijing (CN); Yongqiang Yuan, Beijing (CN)

(21) Appl. No.: 13/638,512

(22) PCT Filed: Mar. 28, 2011
(86) PCT No.: PCT/CN2011/072229

§ 371 Date: Sep. 28, 2012

(30) Foreign Application Priority Data
Mar. 29, 2010 (CN) 201010134360.2

(51) Int. Cl. C21D 1/00; F27D 99/00; C21D 11/00

(52) U.S. Cl. 148/508; 148/538; 266/200; 266/89

(57) ABSTRACT

The application provides a method for manufacturing melt-spinning alloys and an apparatus thereof, which belongs to the technical field of metal materials and preparation thereof. The main feature of method including steps of melting alloy and jetting the molten alloy for rapid-quenching is that alloy melting and rapid-quenching are respectively implemented in independent environments, and the pressure of the two environments can be adjusted separately. The method can realize uniformity control of rapid-quenching velocity by controlling the melting and quenching pressure respectively, which has the advantages of increased rapid-quenching cooling rate, improved melt-spinning alloys thickness uniformity, reduced probability of nozzle clogging.

### TECHNICAL FIELD OF THE INVENTION

The application relates to the technical field of metal materials and preparation thereof, in particular to a method for manufacturing melt-spinning alloys and an apparatus thereof.

### BACKGROUND OF THE INVENTION

Rapid-quenching technology has been widely applied in manufacturing various microcrystalline or amorphous metals and alloys, and has been more widely applied in the field of special magnetic alloy especially. For example, the rapid-quenching method is utilized to manufacture Fe—Ni series, Fe—Ni—Co series, Re₂Fe₁₄B series and rare earth iron nitrogen series alloys. The rapid-quenching method requires devices to be able to provide an extremely great cooling capacity (10⁴-10⁶K/s), so that high-temperature melts would obtain a large degree of supercooling within an extremely short time. At present, the industrial melt rapid-quenching method generally refers to that the molten alloy is jetted to a cooling roller that rotates rapidly at a certain speed to be solidified to form a thin strip that is 0.02-0.05 mm in thickness. In order to improve the cooling capacity, the common method is to increase the surface line velocity (10-80 m/s) of the cooling roller as far as possible, and decrease the surface temperature of the cooling roller as far as possible.

Patents abroad about methods and apparatus for manufacturing melt-spinning alloys are mainly as follows: in 1985, U.S. Pat. No. 4,496,395 disclosed a high coercivity rare earth iron permanent magnet, involving a rapid-quenching preparation technology that the molten alloy is jetted to a cooling roller, the surface line velocity of which is 2.5-25 m/s, at a pressure of 17 kPa for rapid-quenching. In 1989, U.S. Pat. No. 4,836,868 disclosed a permanent magnet and a method for manufacturing the permanent magnet by rapid-quenching. Additionally, there are also patents, such as U.S. Pat. Nos. 5,049,208, 4,802,931, 5,056,585, 5,174,362, 5,172,751 and 5,209,789, Japanese patents P2002-57017A and P2004-63666A and so on. There are mainly following related Chinese patents: CN1430035A, CN1023689C, CN1078258C, CN101241789A, CN201209153Y and so on.

Principles of rapid-quenching method and apparatus involved in the above patents are substantially the same, that the molten alloy is jetted to a cooling roller for rapid-quenching; the difference depends on parameters such as the surface line velocity of the cooling roller or the pressure at which the molten alloy is jetted. According to information disclosed in the above patents, the process of melting alloy by a quartz crucible has a relatively small pressure of jet which will not exceed 0.1 MPa usually; while for the rapid-quenching method of melting alloy by a crucible and then pouring by a tundish, the molten alloy is jetted to the cooling roller via a pressure produced by the self-weight of metal in the tundish.

The above methods generally have the following defects: first, it is unable to precisely control the jet speed of the molten alloy to the cooling roller, resulting in non-uniform thickness of the melt-spinning alloys strip and reduced yield; second, the molten alloy nozzle may be blocked easily, resulting in production interruption; third, a higher cooling speed cannot be obtained. Besides, the rapid-quenching methods disclosed in the above patents generally have one fetal weakness: the molten alloy is basically jetted to the cooling roller from a small single hole, which causes extremely low production efficiency and too high cost.

### SUMMARY OF THE INVENTION

The purpose of the application is to provide a method for manufacturing melt-spinning alloys and an apparatus thereof, to solve the above defects of the existing rapid-quenching methods.

According to one aspect of the application, a method for manufacturing melt-spinning alloys is provided, including the steps of alloy melting and rapid-quenching for jetted the molten alloy, wherein the alloy melting and the rapid-quenching are respectively implemented in independent environments, the environment pressure of the alloy melting is P1, the environment pressure of the rapid-quenching is P2, and P1 and P2 can be adjusted separately.

Further, the P1 and the P2 are adjusted by inflating and/or evacuating.

Further, the P1 and the P2 are in the range of 1.0*10⁻⁴ Pa-5.0*10⁶ Pa.

Further, the rapid-quenching method future includes: controlling the jet speed of the molten alloy by adjusting the pressure difference between the P1 and the P2.

Further, the rapid-quenching method further includes: monitoring the P1 and the P2, and obtaining a monitoring date, adjusting the pressure difference between the P1 and the P2 in accordance with the monitoring data.

Further, the rapid-quenching method further includes: jetting the molten alloy to a rapid-quenching device from a tundish.

Further, the rapid-quenching method further includes: jetting the molten alloy to the rapid-quenching device from at least one opening of a bottom nozzle of the tundish.

Further, the rapid-quenching method further includes: the surface line velocity of the rapid-quenching device is controlled at 5-100 m/s.

Further, the surface line velocity of the rapid-quenching device is 10-60 m/s.

According to another aspect of the application, an apparatus for manufacturing melt-spinning alloys is provided, including: a furnace body, a melting device and a rapid-quenching device, wherein the furnace body has two chambers, a first chamber and a second chamber, which can control the pressure respectively, the melting device is arranged in the first chamber, and the rapid-quenching device is arranged in the second chamber.

Further, the inner chamber of the furnace body is divided into an upper chamber and a lower chamber by a clapboard, the first chamber is the upper chamber, and the second chamber is the lower chamber.

Further, the first chamber and the second chamber are respectively provided with a pressure adjusting system for regulating the inside pressure of the chamber.

Further, the pressure adjusting system includes a pressure control system and/or a vacuum system.

Further, the melting device includes a tundish, a nozzle extending to the second chamber is arranged on the bottom of the tundish, and at least one opening is arrange on the nozzle.

Further, the number of openings is 1-20.

Further, the cross-sectional area of the openings is 0.03-10 mm².

Further, the rapid-quenching device includes a rotatable cooling roller or cooling pan; and the width of the cooling roller or the diameter of the cooling pan is 5-800 mm.

Further, the rapid-quenching device includes a rotatable cooling roller or cooling pan; and the width of the cooling roller or the diameter of the cooling pan is 10-500 mm.

Further, a pressure monitoring device for monitoring the inside pressure is respectively arranged inside the first chamber and the second chamber.

The application has the following beneficial effects.

First, the jet speed of the molten alloy can be controlled in real time, the nozzle is not easy to be blocked, the process is stable, and the uniformity of products is good.

The most prominent feature of the method for manufacturing melt-spinning alloys in the application is that: the pressure of the melting environment and the pressure of the rapid-quenching environment are controlled separately, unstable speed of jet caused by the change of the level of the molten alloy or the nozzle clogging can be eliminated, a quite uniform jet speed of the molten alloy can be obtained. For example, when the flow speed is too fast, the pressure of the rapid-quenching environment may be adjusted to be greater than that of the melting environment, in order to reduce the flow speed; when the flow speed is too slow, the pressure of the rapid-quenching environment may be adjusted to be less than that of the melting environment, in order to increase the flow speed.

Second, the pressure of jetting the molten alloy is great and the flow speed is fast, so that a greater cooling speed can be obtained for rapid-quenching.

For the method for manufacturing melt-spinning alloys in the application, as the pressure of the melting environment may be controlled to be far greater than that of the rapid-quenching environment to obtain a very high pressure difference, the pressure of jetting the molten alloy is very high, the flow speed is fast, and the efficiency is high; furthermore, under same conditions, a higher cooling speed can be obtained.

Third, it is suitable for melting volatile metal or alloy.

The melting environment of a common rapid-quenching furnace is generally in negative pressure, which will cause some volatile metals or alloys having a relatively large vapor pressure at high temperature to volatilize greatly and burn, to cause inaccurate composition of the melt-spinning alloys. While in this method, the pressure of the melting environment may be controlled at 5 MPa at most, the volatilization and burning of volatile metal or alloy are reduced greatly during the melting.

Fourth, continuous production is achievable, the efficiency is high, and the cost is low.

For the method for manufacturing melt-spinning alloys in the application, a tundish is utilized to jet the molten alloy, an automatic feeding device is provided, continuous production can be achieved; furthermore, the nozzle on the bottom of the tundish may be provided with a plurality of openings, this may increase the jet flow of the molten alloy exponentially, thereby improving the production efficiency and reducing the production cost. This method is quite suitable for industrial production. For example, at present, the jet flow of the molten alloy in the common rapid-quenching methods is about 1.0-1.5 kg/min, while the jet flow of the molten alloy in the application can reach 20 kg/min at most.

By the method for manufacturing melt-spinning alloys in the application, problems of rare earth permanent magnetic materials during the preparation process can be solved effectively; materials prepared by this method are mainly neodymium iron boron series and rare earth iron nitrogen series of magnetic materials; compared with the existing methods, the prepared materials have higher performance.

### BRIEF DESCRIPTION OF THE DRAWINGS

FIG. 1 is a structure diagram of an apparatus for manufacturing melt-spinning alloys in the application;

FIG. 2 is a sectional view of a nozzle on the bottom of a tundish in the apparatus for manufacturing melt-spinning alloys in the application in direction A-A.

### DETAILED DESCRIPTION OF THE APPLICATION

The application will be further described with specific embodiments. The protection scope of the application is not limited by these embodiments, and is defined by the claims.

In one embodiment of the application, the method for manufacturing melt-spinning alloys in the application includes: the steps of alloy melting and rapid-quenching for ejected molten alloy, wherein the alloy melting and the rapid-quenching are respectively implemented in independent environments, the environment pressure of the alloy melting is P1, the environment pressure of the rapid-quenching is P2, and P1 and P2 can be adjusted separately. According to the method in the application, by separately controlling the pressure of the melting environment and the pressure of the rapid-quenching environment, the change of the level of the molten alloy or the unstable jet speed can be eliminated, and a quite uniform jet speed of the molten alloy is obtained. For example, when the flow speed is too fast, the pressure of the rapid-quenching environment may be adjusted to be greater than that of the melting environment, in order to reduce the flow speed; when the flow speed is too slow, the pressure of the rapid-quenching environment may be adjusted to be less than that of the melting environment, in order to increase the flow speed.

Preferably, the environment pressure of the melting P1 and the environment pressure of the rapid-quenching P2 may be respectively adjusted by inflating and/or evacuating. Such adjustment method can meet the requirements on P1 and P2 simply and quickly during the preparation of melt-spinning alloys. Of course, the application is not limited to such pressure adjustment method; for the adjustment of P1 and P2, persons skilled in the field are able to utilize any feasible facility or method to implement the adjustment. In the application, gases inflated into the alloy melting environment and the rapid-quenching environment are preferably inert gases, such as argon, helium or nitrogen, more preferably argon, the inflation of inert gases may make the preparation environment of the melt-spinning alloys in the application as inert gases environment, which can ensure that alloy powder will not be oxidized during the manufacture process, and the jetted pressure difference is also controlled by adjusting the pressure of gas.

Preferably, the value range of the environment pressure of the melting P1 and the environment pressure of the rapid-quenching P2 is 1.0*10⁻⁴ Pa-5.0*10⁶ Pa. In the application, the pressure range of P1 and P2 is defined because that when the pressure exceeds 5 MPa, the tolerance capacity of the existing apparatus is exceeded, while the ultimate vacuum of the vacuum system in the existing apparatus at present is within 10⁻⁴ Pa, when the tolerance capacity of the used apparatus exceeds this range, the pressure range of P1 and P2 in the method for manufacturing melt-spinning alloys is not limited thereto. Besides, melting environment of a common rapid-quenching furnace is generally in negative pressure, which will cause some volatile metals or alloys having a relatively large vapor pressure at high temperature to volatilize greatly and burn, to cause inaccurate composition of the melt-spinning alloys. While in this method, the pressure of the melting environment may be controlled at 5 MPa at most, the volatilization and burning of volatile metal or alloy are reduced greatly during the melting.

Preferably, the rapid-quenching method in the method for manufacturing melt-spinning alloys in the application further includes: controlling the jet speed of the molten alloy by adjusting the pressure difference between the P1 and the P2. In the method for manufacturing melt-spinning alloys in the application, P1 and P2 may be adjusted separately, by adjusting P1 and P2, the pressure difference between P1 and P2 may be positive or negative, and by continuously adjusting P1 and P2, the pressure difference between P1 and P2 may change continuously until the proper jet speed of the molten alloy is obtained. When the jet speed of the molten alloy is too slow to cause unsmooth jet of the molten alloy, the jet pressure difference is increased; when the jet speed is too fast, the rapid-quenching device is too hurry to implement rapid-quenching, the pressure difference is decreased in order to make the molten alloy rapid-quench uniformly and stably. Simultaneously, the environment pressure of the melting P1 also may be controlled to be far greater than the environment pressure of the rapid-quenching P2, in order to obtain a very high pressure difference, therefore the jet pressure of the molten alloy is very high, the flow speed is fast, and the efficiency is high; furthermore, under same conditions, a higher cooling speed can be obtained.

In the method for manufacturing melt-spinning alloys, the molten alloy is jetted via the nozzle for rapid-quenching, it may be directly jetted to obtain small spherical powder, and it also may be jetted to the water-cooling roller for rapid-quenching to form flakes. In order to obtain a higher cooling speed, the latter is preferable in the application.

Preferably, the rapid-quenching method in the method for manufacturing melt-spinning alloys in the application may further include: monitoring the environment pressure of the melting P1 and the environment pressure of the rapid-quenching P2, and obtaining a monitoring date, adjusting the pressure difference between the P1 and the P2. By monitoring P1 and P2, the adjustment of P1 and P2 may be selected better, so as to avoid causing pressure to the apparatus by excessively adjusting P1 or P2.

In one embodiment of the application, the rapid-quenching method in the method for manufacturing melt-spinning alloys in the application further includes: jetting the molten alloy to a rapid-quenching device from a tundish. Preferably, the rapid-quenching method further includes: jetting the molten alloy to the rapid-quenching device from at least one opening of a bottom nozzle of the tundish. In this method, when the molten alloy is jet from at least one opening on the nozzle, particularly jet from a plurality of openings, on one hand, the nozzle can be prevented from being blocked when the molten alloy is jetted, on the other hand, the jet flow of the molten alloy can be increased exponentially, thereby improving the production efficiency and reducing the production cost. This method is quite suitable for industrial production. For example, at present, the jet flow of the molten alloy in the common rapid-quenching methods is about 1.0-1.5 kg/min, while the jet flow of the molten alloy in the application can reach 20 kg/min at most. During this process, the molten alloy is poured to a tundish with a nozzle on the bottom thereof, in order to keep the alloy inside the tundish and nozzle in the molten state, the tundish and the nozzle are provided with heating devices, and the heating temperature is controlled by current, thus to ensure that the temperature of the molten alloy is controllable.

Preferably, the number of openings on the nozzle is 1-20, keeping the number of openings within the range not only can achieve the above effects, but also can balance the compact structure of the apparatus. Preferably, there are 1-10 openings, and more preferably, there are 3-10 openings. In the preferred solutions of the application, the cross-sectional area of the openings on the nozzle is 0.03-10 mm². Too small cross-sectional area of the openings on the nozzle may cause nozzle clogging, which is not good for the molten alloy to flow out; too large cross-sectional area may cause too fast jet speed of the molten alloy, so as to cause non-uniform thin alloy strips. In the application, openings with a cross-sectional area of 0.1-2.0 mm² are used, more preferably, openings with a cross-sectional area of 0.3-1.2 mm².

In one embodiment of the application, the rapid-quenching method in the method for manufacturing melt-spinning alloys in the application further includes: controlling the surface line velocity of the rapid-quenching device at 5-100 m/s, in the application, the selection of the surface line velocity may depend on the requirements of the process and the pressure difference between P1 and P2. When the pressure of the melting environment P1 is greater than the pressure of the rapid-quenching environment P2, the surface line velocity of the rapid-quenching device may be gradually increased according to practical situation. More preferably, the surface line velocity of the rapid-quenching device is 10-60 m/s.

In view of cost and efficiency, medium frequency induction melting is employed as the melting mode of the method for manufacturing melt-spinning alloys in common cases, so that the uniformity of organization and composition of the molten alloy as well as the controllability of the temperature of the molten alloy can be guaranteed, and the fluidity of the alloy solution when jetted can be guaranteed; if the purity of the alloy is required highly, magnetic suspension melting may be selected. Electric arc melting or electron beam melting may be selected to melt high-melting-point refractory metal or alloy.

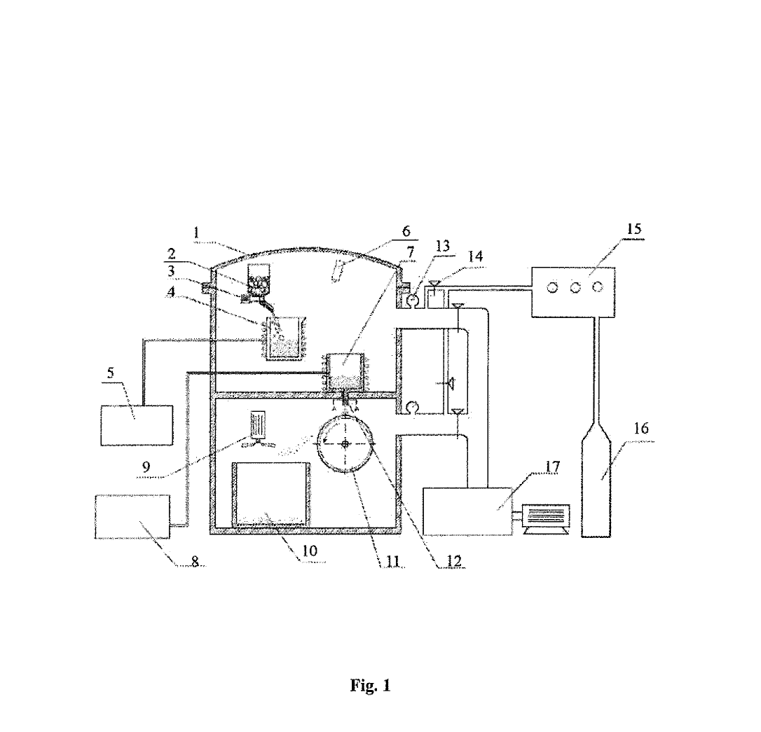

FIG. 1 shows an apparatus for manufacturing melt-spinning alloys in the application, in one embodiment of the application, the apparatus for manufacturing melt-spinning alloys includes a furnace body 1, a melting device and a rapid-quenching device 11, the furnace body 1 is has two chambers, a first chamber and a second chamber, which can control the pressure of respectively, the melting device is arranged in the first chamber, and the rapid-quenching device is arranged in the second chamber. In the apparatus for manufacturing melt-spinning alloys in the application, by separately controlling the pressure of the first chamber and the pressure of the second chamber, the change of the level of the molten alloy or the unstable jet speed during the rapid-quenching method can be eliminated, and a quite uniform jet speed of the molten alloy can be obtained.

In a relatively specific way, the inner chamber of the furnace body 1 is divided into an upper chamber and a lower chamber by a clapboard, the first chamber is the upper chamber, and the melting device is arranged in the upper chamber; the second chamber is the lower chamber, and the rapid-quenching device is arranged in the lower chamber. The clapboard is preferably a steel plate. The inner chamber of the furnace body is separated by a clapboard, such structure is easy to be manufactured, and also, the existing apparatuses for manufacturing melt-spinning alloys may be improved to the apparatus for manufacturing melt-spinning alloys in the application by setting clapboard, of course, such improved apparatuses are further included within the protection scope of the application.

Preferably, the first chamber and the second chamber are respectively provided with a pressure adjustment system for adjusting the inside pressure of the chamber. In the application, preferably, such pressure adjustment system includes a pressure control system 15 and/or a vacuum system 17. The pressure control system 15 and the vacuum system 17 may be used respectively, and also may be used simultaneously. Of course, in the apparatus for manufacturing melt-spinning alloys in the application, the pressure adjustment system is not limited to the selection and use of the pressure control system 15 and/or vacuum system 17. Persons skilled in the field may utilize any feasible pressure adjustment system.

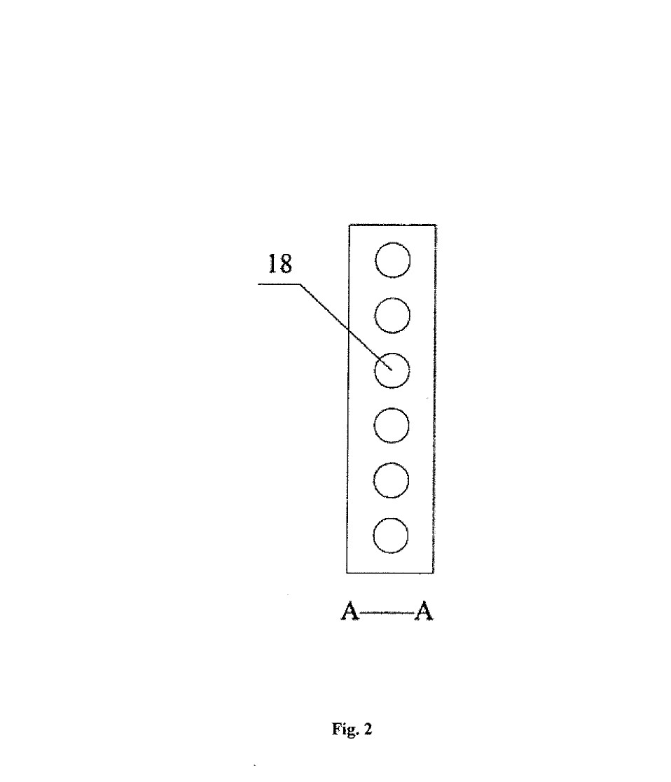

As shown in FIG. 2, in one embodiment of the application, the melting device in the apparatus for manufacturing melt-spinning alloys includes a tundish 7, a nozzle extending to the second chamber is arranged on the bottom of the tundish 7, and at least one opening 18 is arrange on the nozzle. The increase of the number of the openings on the nozzle can prevent the nozzle from being blocked when the molten alloy is jet on one hand, and on the other hand, it also can increase the jet flow of the molten alloy exponentially, thereby improving the production efficiency and reducing the production cost. As the nozzle works at high temperature and high pressure for a long term during the use, it has to be made of high-strength, high-temperature resistant and corrosion resistant materials, such as diamond, boron nitride and quartz.

Preferably, the number of openings is 1-20, keeping the number of openings within the range not only can achieve the above effects, but also can balance the compact structure of the apparatus. Preferably, there are 1-10 openings, and more preferably, there are 3-10 openings. In another preferred solution of the application, the cross-sectional area of the openings on the nozzle is 0.03-10 mm². Too small cross-sectional area of the openings on the nozzle may cause nozzle clogging, which is not good for the molten alloy to flow out; too large cross-sectional area may cause too fast jet speed of the molten alloy, so as to cause non-uniform thin alloy strips. In the application, openings with a cross-sectional area of 0.1-2.0 mm² are used, more preferably, openings with a cross-sectional area of 0.3-1.2 mm².

Preferably, in the apparatus for manufacturing melt-spinning alloys in the application, the rapid-quenching device includes a rotatable cooling roller or cooling pan; and the width of the cooling roller or the diameter of the cooling pan is 5-800 mm. In the application, the width of the cooling roller means the axial length of the cooling roller. The width of the cooling roller or the diameter of the cooling pan may be selected according to the number of the openings on the nozzle, when the number of the openings is increased, the width of the cooling roller or the diameter of the cooling pan may be increased appropriately. Preferably, the width of the cooling roller or the diameter of the cooling pan is 5-800 mm, and more preferably 10-500 mm. In the application, the cooling roller or cooling pan is made of any one of copper, copper alloy, molybdenum, molybdenum alloy, iron, iron alloy, tungsten, tungsten alloy, titanium and titanium alloy, preferably, molybdenum alloy or copper alloy; the cooling medium used in the cooling roller or cooling pan is at least one of water, liquid nitrogen and oil, in view of cost and operability during the production, water is selected as the cooling medium in the application.

Preferably, a pressure monitoring device 13 for monitoring the inside pressure of the chambers is also respectively arranged inside the first chamber and the second chamber in the apparatus for manufacturing melt-spinning alloys in the application. As shown in FIG. 1, the pressure monitoring device may be a pressure gauge, in the application, the pressure monitoring device is not limited to pressure gauge, it may be a pressure sensing device; the apparatus also may be provided with a control system, the control system can be connected with the pressure monitoring device and can control the pressure control system according to data fed by the pressure monitoring device, in order to adjust the pressure in the first chamber and the second chamber.

In one specific embodiment of the application, the apparatus for manufacturing melt-spinning alloys includes: a furnace body 1, a feeding system 2, a feeding motor 3, a melting crucible 4, a crucible heating system 5, a temperature testing system 6, a tundish 7, a tundish heating system 8, a cooling fan 9, a receiving system 10, a rapid-quenching device 11, a nozzle 12 on the bottom of the tundish, a pressure gauge 13, a vacuum solenoid 14, a pressure control system 15, a gas source 16, a vacuum system 17, and openings 18. Wherein, the inner chamber of the furnace body 1 is divided into an independent first chamber and a second chamber by a clapboard; the feeding system 2, the feeding motor 3, the melting crucible 4, the temperature testing system 6 and the tundish 7 are arranged in the first chamber; and the cooling fan 9, the feeding system 10 and the rapid-quenching device 11 are arranged in the second chamber. Alloy is poured into the melting crucible 4 by the feeding system 2 via the feeding motor 3, the melting crucible 4 is heated by the crucible heating system 5, the molten alloy is poured into the tundish 7 from the melting crucible 4, the tundish 7 is heated by the tundish heating system 8, a nozzle extending to the second chamber is arranged on the bottom of the tundish 7, the rapid-quenching device 11 is arranged correspondingly to the nozzle, and at least one opening 18 is arrange on the nozzle. The first chamber and the second chamber are respectively connected with the pressure control system 15 and the vacuum system 17 to adjust inside pressure of the chambers. Wherein, a vacuum solenoid valve 14 is respectively arranged on the connection paths of the pressure control system 15 and the vacuum system 17 with the first chamber and the second chamber. The pressure control system 15 is connected with the gas source 16, and the gas source is an inert gases source. Besides, the first chamber and the second chamber are respectively provided with a pressure gauge 13 to monitor the inside pressure of the chambers.

In the embodiment, the feeding system 2 includes a storage bin, a motor and a chute. The temperature testing system 6 includes a temperature sensor, a data transmission line, a computer and a display screen, so that the temperature of the molten alloy in the melting crucible and the tundish can be measured. The temperature testing system 6 employs thermocouple or infrared thermometry, so that the temperature of the molten alloy both in the melting crucible and the tundish can be measured simultaneously, the highest temperature to be measured can reach 2000□. The receiving system 10 includes a receiving bin and a cooling fan. The vacuum system generally includes a mechanical pump and a roots pump, a diffusion pump may be added according to the requirement of the degree of vacuum. The gas pressure control system includes a gas flow meter, a vacuum gauge, a pressure gauge, a vacuum solenoid valve, a computer and a gas source.

The beneficial effects of the application will be further described below in combination with specific embodiments utilizing the method and apparatus for manufacturing melt-spinning alloys in the application and comparative examples.

To make the description clear, in the embodiments, characters are used to replace specific parameters: the number of openings N, the cross-sectional area of openings S (mm²), the surface width of the cooling roller L (mm), and the line velocity V (m/s) of the cooling roller.

In terms of magnetic property of materials, the unit of iHc is kOe, the unit of Br is kGs, and the unit of (BH)m is MGOe.

### Embodiments 1-30 of the Application

Apparatus: the apparatus for manufacturing melt-spinning alloys in the application, with a structure as shown in FIG. 1.

Implementation Process:

(1) Preparation of Neodymium Iron Boron Series of Magnetic Materials

This series of materials may be Rₓ(Fe_{1-y}M_{y})_{100-x-z}B_{z}, this material mainly contains R₂Fe₁₄B, 4≦x≦15 at %, 0.5≦z≦20 at %, 0≦y≦0.5 at %, and M is one or more of Zr, Hf, Mn, Ti, Si, V, Co, Ni, Cr, Mo, Al, Nb, Ga, Ta, Cu, Zn.

Raw materials with this composition were put into the storage bins of the melting crucible and feeding system, the circulating water system was opened, and the melting and rapid-quenching two chambers were evacuated to below 1.0*10⁻³ Pa. The vacuum system was closed, and the two chambers were inflated with argon to 5.0*10⁴ Pa.

The crucible heating system and the tundish heating system were opened to start melting raw materials; simultaneously, the tundish and the nozzle on the bottom of the tundish were pre-heated. After raw materials inside the crucible were completely molten, the cooling roller and the cooling fan in the receiving bin were opened, the surface line velocity of the cooling roller was adjusted, the molten alloy inside the crucible was poured into the tundish, the alloy solution was jet from the nozzle, and rapid-quenching was started.

During the rapid-quenching method, the pressure adjustment system automatically controlled and kept the pressure difference between the pressure P1 of the melting chamber and the pressure P2 of the rapid-quenching chamber stable; simultaneously, real-time monitoring might be implemented for the rapid-quenching situation via an observation window, the pressure state and the pressure difference between P1 and P2 were adjusted manually according to the rapid-quenching state, the temperature testing system automatically controlled the tundish heating power supply to keep the temperature of the molten alloy inside the tundish stable, in order to keep the rapid-quenching method stable.

Rapid-quenching ends, after the inside temperature of the receiving bin was cooled to room temperature, the alloy was taken out from the furnace to obtain the rapid-quenched neodymium iron boron alloy powder. The obtained alloy powder was put into a crystallization furnace for thermal treatment at 600-800□ for 5 min-3 h, after treatment, isotropic neodymium iron boron magnetic powder with excellent performance was obtained.

### COMPARATIVE EXAMPLES 1-13

Apparatus: a common rapid-quenching furnace was employed for rapid-quenching to prepare materials. In comparison of the apparatuses used in the comparative examples with the apparatus provided in the application, both melting and rapid-quenching were implemented in one chamber, there was one opening on the nozzle, simultaneously, alloy solution flowed from the nozzle due to self-weight, and the flow speed could not be controlled by adjusting the pressure of both the melting environment and the rapid-quenching environment. To make the comparison more persuasive, except that the preparation method was different during the rapid-quenching method, the composition of materials and the thermal treatment process were the same as those in the embodiments. For SmFeN series of materials, the subsequent granularity of powder prepared by initial crushing, the nitriding temperature and time, and other processes were completely the same as those in the embodiments.

Implementation process: conventional methods adequate to the apparatus.

Materials, which were manufactured by using the embodiments 1-30 of the apparatus and method provided in the application and by using the embodiments 1-13 of the apparatus mentioned in comparative examples, were tested in terms of magnetic performance. Related data of using the embodiments 1-30 of the apparatus and method provided in the application was filled into Table 1; and related data of using the embodiments 1-13 of the apparatus mentioned in comparative examples was filled into Table 2.

TABLE 1

| No. | N | S | L | V | Composition | iHc | Br | (BH)m |
|---|---|---|---|---|---|---|---|---|
| Embodiment 1 | 3 | 0.35 | 17 | 22 | Nd12.5FebalB1.1 | 10.2 | 7.6 | 15.7 |
| Embodiment 2 | 6 | 0.3 | 50 | 30 | Nd3.5Pr4.5FebalNb0.5B6 | 9.3 | 8.6 | 15.8 |
| Embodiment 3 | 1 | 10 | 200 | 40 | Nd7FebalSi1.5Co3Ta0.8B20 | 9.7 | 8.6 | 15.7 |
| Embodiment 4 | 3 | 1.2 | 30 | 25 | Nd11.5FebalCoZr1.0Ga0.3B1.5 | 10.6 | 6.4 | 14.8 |
| Embodiment 5 | 20 | 0.03 | 100 | 60 | Nd8.5Dy1.0FebalHf0.1Ti0.5B0.9 | 9.7 | 8.1 | 15.7 |
| Embodiment 6 | 12 | 0.1 | 60 | 30 | Nd15FebalCo15A12.5Cr0.1B1.1 | 9.8 | 9.5 | 16.7 |
| Embodiment 7 | 10 | 0.3 | 80 | 25 | Nd4La1.5FebalZr1.0V1.5B17 | 8.2 | 8.7 | 14.8 |
| Embodiment 8 | 1 | 2.0 | 5 | 10 | Nd13.0FebalCo9Ni1.2MoB0.5 | 9.9 | 8.2 | 15.1 |
| Embodiment 9 | 16 | 0.9 | 90 | 100 | Nd10.5Dy1FebalCo5Cu1.5Mn1B0.9 | 9.6 | 8.5 | 15.9 |
| Embodiment | 4 | 0.9 | 10 | 15 | Nd12.5FebalCo0.5B1 | 10.0 | 7.3 | 15.1 |
| 10 | | | | | | | | |
| Embodiment | 4 | 0.9 | 10 | 15 | Nd10.8Dy1.0FebalCo0.3B0.9 | 9.6 | 8.6 | 16.1 |
| 11 | | | | | | | | |
| Embodiment | 4 | 0.9 | 10 | 17 | Nd12.5FebalCo0.3Nb0.2B1.1 | 10.5 | 7.1 | 16.5 |
| 12 | | | | | | | | |
| Embodiment | 4 | 0.7 | 10 | 17 | Nd12.5FebalCo0.5B1 | 9.6 | 8.2 | 16.4 |
| 13 | | | | | | | | |
| Embodiment | 5 | 0.7 | 15 | 20 | Nd12.5FebalCo0.5Zr1.0B | 9.6 | 8.0 | 15.5 |
| 14 | | | | | | | | |
| Embodiment | 5 | 0.7 | 15 | 20 | Nd4Pr1FebalNv0.5B15 | 10.3 | 6.9 | 16.4 |
| 15 | | | | | | | | |
| Embodiment | 5 | 0.5 | 15 | 23 | Nd12.5FebalCo0.3Zr0.2B1 | 9.9 | 7.8 | 15.9 |
| 16 | | | | | | | | |
| Embodiment | 5 | 0.5 | 15 | 23 | Nd10.8Dy1.0FebalCo0.3B0.9 | 9.1 | 8.7 | 15.5 |
| 17 | | | | | | | | |
| Embodiment | 6 | 0.5 | 20 | 25 | Nd2.5FebalCo0.5B1 | 10.6 | 6.1 | 15.8 |
| 18 | | | | | | | | |
| Embodiment | 6 | 0.3 | 20 | 25 | Nd11dLa1.5FebalCo0.3B1 | 9.5 | 9 | 16.3 |
| 19 | | | | | | | | |
| Embodiment | 6 | 0.3 | 20 | 30 | Nd12.5FebalCo0.3Zr0.2B1 | 9.4 | 8.2 | 15.8 |
| 20 | | | | | | | | |
| Embodiment | 6 | 0.3 | 20 | 30 | Nd4Pr1FebalNb0.5B15 | 9.7 | 8.5 | 16.1 |
| 21 | | | | | | | | |
| Embodiment | 15 | 0.4 | 120 | 20 | Nd12.5FebalCo0.5B1 | 9.3 | 7.1 | 17.9 |
| 22 | | | | | | | | |
| Embodiment | 18 | 0.3 | 100 | 23 | Nd12.5FebalCoZr0.5B1 | 9.9 | 5.7 | 15.7 |
| 23 | | | | | | | | |
| Embodiment | 20 | 0.3 | 500 | 10 | Nd12.5FebalCo1.2B1.1 | 9.1 | 7.4 | 16.5 |
| 24 | | | | | | | | |
| Embodiment | 20 | 0.5 | 300 | 17 | Nd10.5Pr2.0FebalCo0.2B1.1 | 9.8 | 8.3 | 16.1 |
| 25 | | | | | | | | |
| Embodiment | 15 | 0.5 | 100 | 15 | Nd12.5FebalCoA10.31.2B1.2 | 10.1 | 9.4 | 15.8 |
| 26 | | | | | | | | |
| Embodiment | 20 | 0.7 | 150 | 32 | Nd12.5FebalCu0.2B1.1 | 10.2 | 9.4 | 16.7 |
| 27 | | | | | | | | |
| Embodiment | 12 | 0.5 | 100 | 16 | Nd12.7FebalCo1.5B1 | 9.4 | 9.1 | 15.6 |
| 28 | | | | | | | | |
| Embodiment | 20 | 0.5 | 400 | 12 | Nd2.7FebalCo1.3Ga0.5B1.2 | 9.5 | 8.5 | 16.5 |
| 29 | | | | | | | | |
| Embodiment | 20 | 0.7 | 800 | 5 | Nd12.7FebalGa0.5B1.2 | 9.7 | 9.2 | 15.5 |
| 30 | | | | | | | | |

TABLE 2

| No. | N | S | L | V | Composition | iHc | Br | (BH)m |
|---|---|---|---|---|---|---|---|---|
| Embodiment 1 | 1 | 0.35 | 17 | 22 | Nd12.5FebalB1.1 | 9.0 | 7.7 | 14.9 |
| Embodiment 2 | 1 | 0.9 | 10 | 15 | Nd12.5FebalCo0.5B1 | 8.4 | 8.6 | 15.9 |
| Embodiment 3 | 1 | 0.9 | 10 | 15 | Nd10.8Dy1.0FebalCo0.3B0.9 | 7.6 | 8.3 | 14.1 |
| Embodiment 4 | 1 | 0.9 | 10 | 17 | Nd12.5FebalCo0.3Nb0.2B1.1 | 9.2 | 7.8 | 14.3 |
| Embodiment 5 | 1 | 0.7 | 10 | 17 | Nd12.5FebalCo0.5B1 | 8.9 | 8.2 | 15.3 |
| Embodiment 6 | 1 | 0.7 | 15 | 20 | Nd12.5FebalCo0.5Zr1.0B | 9.8 | 6.7 | 15.7 |
| Embodiment 7 | 1 | 0.7 | 15 | 20 | Nd4Pr1FebalNb0.5B15 | 8.9 | 7.8 | 15.6 |
| Embodiment 8 | 1 | 0.5 | 15 | 23 | Nd12.5FebalCo0.3Zr0.2B1 | 9.5 | 7.2 | 14.9 |
| Emb0.5odiment 9 | 1 | 0.5 | 15 | 23 | Nd10.8Dy1.0FebalCo0.3B0.9 | 8.6 | 8.2 | 15.0 |
| Embodiment 10 | 1 | 0.5 | 20 | 25 | Nd12.5FebalCo0.5B1 | 9.0 | 8.2 | 14.9 |
| Embodiment 11 | 1 | 1.3 | 20 | 25 | Nd11dLa1.5FebalCo0.3B1 | 9.9 | 6.1 | 14.1 |
| Embodiment 12 | 1 | 0.3 | 20 | 30 | Nd12.5FebalCo0.3Zr0.2B1 | 8.9 | 8.1 | 15.1 |
| Embodiment 13 | 1 | 0.3 | 20 | 30 | Nd4Pr1FebalNb0.5B15 | 9.3 | 6.7 | 14.3 |

(2) Rare Earth Iron Nitrogen Series of Magnetic Materials

This series of materials also may be Rₓ(Fe_{1-y}M_{y})_{100-x-z}N_{z}, wherein 5≦x≦15 at %, 5≦z≦20 at %, 0≦y≦0.5 at %, and M was one or more of Zr, Hf, Ti, Si, V, Co, Cr, Mo, Al, Nb, Ga, Ta and Cu.

### Embodiments 31-55 of the Application

Apparatus: the same as that used in embodiments 1-30.

Preparation Process:

Raw materials with certain composition were put into the storage bins in the melting crucible and feeding system, the circulating water system was opened, and the melting and rapid-quenching two chambers were evacuated to below 1.0*10⁻³ Pa. The vacuum system was closed, and the two chambers were inflated with argon to 5.0*10⁴ Pa.

The crucible heating system and the tundish heating system were opened to start melting raw materials; simultaneously, the tundish and the nozzle on the bottom of the tundish were pre-heated. After raw materials inside the crucible were completely molten, the cooling roller and the cooling fan in the receiving bin were opened, the surface line velocity of the cooling roller was adjusted, the molten alloy inside the crucible was poured into the tundish, the alloy solution was jet from the nozzle, and rapid-quenching was started.

During the rapid-quenching method, the pressure adjustment system automatically controlled and kept the pressure difference between the pressure P1 of the melting chamber and the pressure P2 of the rapid-quenching chamber stable; simultaneously, real-time monitoring may be implemented for the rapid-quenching situation via an observation window, the pressure state and the pressure difference between P1 and P2 were adjusted manually according to the rapid-quenching state, the temperature testing system will automatically control the tundish heating power supply to keep the temperature of the molten alloy inside the tundish stable, in order to keep the rapid-quenching method stable.

Rapid-quenching ends, after the inside temperature of the receiving bin was reduced to room temperature, the alloy was taken out from the furnace to obtain the rapid-quenched RFeM alloy.

The obtained rapid-quenched RFeM alloy was put into a crystallization furnace for thermal treatment at 600-800□ for 5 min-3 h, the treated alloy was initially crushed to obtain powder 10-70 um, the powder was put into a tubular furnace inflated with argon and hydrogen for nitriding at 400-600□ for 1-5 h, then high-performance rare earth iron nitrogen powder was obtained.

### COMPARATIVE EXAMPLES 14-25

Apparatus: the same as that used in comparative examples 1-13.

Implementation process: the same as that in comparative examples 1-13.

Materials, which were manufactured by using the embodiments 31-55 of the apparatus and method provided in the application and by using the embodiments 14-25 of the apparatus mentioned in comparative examples, were tested in terms of magnetic performance. Related data of using the embodiments 31-55 of the apparatus and method provided in the application was filled into Table 3; and related data of using the embodiments 14-25 of the apparatus mentioned in comparative examples was filled into Table 4.

TABLE 3

| No. | N | S | L | V | Composition | iHc | Br | (BH)m |
|---|---|---|---|---|---|---|---|---|
| Embodiment | 6 | 0.3 | 50 | 30 | Sm8.5FebalZr1.5N12.5 | 8.6 | 8.8 | 17.8 |
| 31 | | | | | | | | |
| Embodiment | 1 | 10 | 200 | 40 | Nd5FebalMo1.5N10.5 | 7.5 | 8.4 | 18.7 |
| 32 | | | | | | | | |
| Embodiment | 3 | 1.2 | 30 | 25 | Nd6.3FebalTi1.5N11.5 | 7.8 | 8.5 | 18.5 |
| 33 | | | | | | | | |
| Embodiment | 20 | 0.03 | 100 | 60 | Nd6.5FebalV2.0Mn2.5N5 | 8.9 | 8.0 | 17.7 |
| 34 | | | | | | | | |
| Embodiment | 12 | 0.1 | 60 | 30 | Sm8.7FebalNi2.0N15 | 6.7 | 8.6 | 19.3 |
| 35 | | | | | | | | |
| Embodiment | 10 | 0.3 | 80 | 25 | Sm8.0FebalCu1.5N20 | 8.8 | 9.2 | 18.6 |
| 36 | | | | | | | | |
| Embodiment | 1 | 2.0 | 5 | 10 | Sm15FebalCo1.5Hf0.3N12.5 | 8.8 | 8.6 | 17.7 |
| 37 | | | | | | | | |
| Embodiment | 16 | 09 | 90 | 100 | SmFebalCo3.5Ga0.2N12.5 | 9.6 | 7.8 | 18.2 |
| 38 | | | | | | | | |
| Embodiment | 4 | 0.9 | 10 | 30 | Sm10.5FebalCo5Nb0.2N10.5 | 8.4 | 8.6 | 18.1 |
| 39 | | | | | | | | |
| Embodiment | 4 | 0.9 | 10 | 30 | Sm8.5FebalN12.5 | 8.5 | 7.9 | 17.9 |
| 40 | | | | | | | | |
| Embodiment | 4 | 0.9 | 10 | 35 | Sm8.5FebalZr0.5Co8N12.2 | 8.7 | 8.6 | 17.9 |
| 41 | | | | | | | | |
| Embodiment | 4 | 0.7 | 10 | 35 | Sm8.5FebalZr1.5N12.5 | 7.4 | 9.6 | 18.5 |
| 42 | | | | | | | | |
| Embodiment | 5 | 0.7 | 15 | 40 | Sm8.7FebalCo11Hf0.5N12.5 | 7.9 | 9.3 | 18.7 |
| 43 | | | | | | | | |
| Embodiment | 5 | 0.7 | 15 | 40 | Sm9.1FebalCo6.5Si0.5N | 8.8 | 8.2 | 18.1 |
| 44 | | | | | | | | |
| Embodiment | 5 | 0.5 | 15 | 45 | Nd7.1FebalMo1.5N13.5 | 6.8 | 8.4 | 18.6 |
| 45 | | | | | | | | |
| Embodiment | 5 | 0.5 | 15 | 45 | Sm8.5FebalZr1.5N12.5 | 8.7 | 9.4 | 19.3 |
| 46 | | | | | | | | |
| Embodiment | 6 | 0.5 | 20 | 50 | Sm8.5FebalZrCo7.5N12.2 | 8.9 | 8.4 | 17.7 |
| 47 | | | | | | | | |
| Embodiment | 6 | 0.3 | 20 | 50 | Nd7.5FebalTi0.2N13.5 | 8.5 | 7.4 | 17.8 |
| 48 | | | | | | | | |
| Embodiment | 6 | 0.3 | 20 | 55 | Sm9.5FebalCo20N12.5 | 8.8 | 8.4 | 17.7 |
| 49 | | | | | | | | |
| Embodiment | 6 | 0.3 | 20 | 55 | Sm8.0Dy0.5FebalN12.5 | 10.6 | 8.9 | 17.8 |
| 50 | | | | | | | | |
| Embodiment | 20 | 0.7 | 120 | 35 | Sm8.6FebalCo7.5Nb1.1N12.6 | 10.3 | 9.1 | 19.0 |
| 51 | | | | | | | | |
| Embodiment | 15 | 0.5 | 110 | 30 | Sm8.8FebalCo30.0Zr0.7N12.5 | 9.1 | 7.7 | 18.1 |
| 52 | | | | | | | | |
| Embodiment | 16 | 0.6 | 80 | 40 | Sm8.1FebalCo20.1Si0.8N12.6 | 11.3 | 8.2 | 17.8 |
| 53 | | | | | | | | |
| Embodiment | 20 | 0.7 | 100 | 32 | Sm9.2FebalCo12.5Zr0.8N13.0 | 9.8 | 9.4 | 18.2 |
| 54 | | | | | | | | |
| Embodiment | 20 | 0.4 | 100 | 40 | Sm8.9FebalCo11.9Zr0.4N12.5 | 10.7 | 7.9 | 18.6 |
| 55 | | | | | | | | |

TABLE 4

| No. | N | S | L | V | Composition | iHc | Br | (BH)m |
|---|---|---|---|---|---|---|---|---|
| Embodiment 14 | 1 | 0.9 | 10 | 30 | Sm10.5FebalCo5Nb0.2N10.5 | 7.6 | 7.5 | 15.9 |
| Embodiment 15 | 1 | 0.9 | 10 | 30 | Sm8.5FebalN12.5 | 7.2 | 7.6 | 16.0 |
| Embodiment 16 | 1 | 0.9 | 10 | 35 | Sm8.5FebalZr0.5Co8N12.2 | 7.8 | 7.6 | 16.7 |
| Embodiment 17 | 1 | 0.7 | 10 | 35 | Sm8.5FebalZr1.5N12.5 | 7.8 | 7.9 | 17.4 |
| Embodiment 18 | 1 | 0.7 | 15 | 40 | Sm8.7FebalCo11Hf0.5N12.5 | 7.2 | 9 | 16.3 |
| Embodiment 19 | 1 | 0.7 | 15 | 40 | Sm9.1FebalCo6.5Si0.5N | 6.7 | 8.7 | 17.0 |
| Embodiment 20 | 1 | 0.5 | 15 | 45 | Nd7.1FebalMo1.5N13.5 | 6.2 | 9.1 | 16.8 |
| Embodiment 21 | 1 | 0.5 | 15 | 45 | Sm8.5FebalZr1.5N12.5 | 7.6 | 7.7 | 16.7 |
| Embodiment 22 | 1 | 0.5 | 20 | 50 | Sm8.5FebalZrCo7.5N12.2 | 7.2 | 9.1 | 16.8 |
| Embodiment 23 | 1 | 0.3 | 20 | 50 | Nd7.5FebalTi2.0N13.5 | 6.3 | 8.4 | 16.4 |
| Embodiment 24 | 1 | 0.3 | 20 | 55 | Sm9.5FebalCo20N12.5 | 7.8 | 7.4 | 16.0 |
| Embodiment 25 | 1 | 0.3 | 20 | 55 | Sm8.0Dy0.5FebalN12.5 | 8.3 | 6.2 | 15.4 |

It can be seen from data in Table 1 to Table 4 that, by the method and apparatus for manufacturing melt-spinning alloys provided in the application, alloy melting and rapid-quenching were respectively implemented in two independent environments, the preparation of alloy powder can be effectively guaranteed to be stable and uniform, and the prepared magnetic powder has higher magnetic performance; simultaneously, by controlling the number of the nozzle and the cross-sectional area of the nozzle, the production efficiency is improved effectively, the nozzle clogging during the alloy jet process is avoided, the production cost is reduced, the continuous production of alloy is guaranteed, and the production efficiency is further improved.

The above is only the preferred embodiment of the invention and not intended to limit the invention. For those skilled in the art, various alterations and changes may be made to the invention. Any modifications, equivalent replacements, improvements and the like made within the spirit and principle of the invention shall fall within the scope of protection of the invention.

1. A method for manufacturing melt-spinning alloys, including the steps of alloy melting and rapid-quenching for ejected molten alloy, wherein the alloy melting and the rapid-quenching are respectively implemented in independent environments, the environment pressure of the alloy melting is P1, the environment pressure of the rapid-quenching is P2, and P1 and P2 can be adjusted separately.

2. The method according to claim 1, wherein the P1 and the P2 are adjusted by inflating and/or evacuating.

3. The method according to claim 1, wherein the P1 and the P2 are in the range of 1.0*10⁻⁴ Pa-5.0*10⁶ Pa.

4. The method according to claim 3, wherein the rapid-quenching method future includes: controlling the jet speed of the molten alloy by adjusting the pressure difference between the P1 and the P2.

5. The method according to claim 4, wherein the rapid-quenching method further includes:
monitoring the P1 and the P2, and obtaining a monitoring date,
adjusting the pressure difference between the P1 and the P2 in accordance with the monitoring data.

6. The method according to claim 1, wherein the rapid-quenching method further includes: jetting the molten alloy to a rapid-quenching device from a tundish.

7. The method according to claim 6, wherein the rapid-quenching method further includes: jetting the molten alloy to the rapid-quenching device from at least one opening of a bottom nozzle of the tundish.

8. The method according to claim 6, wherein the rapid-quenching method further includes: the surface line velocity of the rapid-quenching device is controlled at 5-100 m/s.

9. The method according to claim 8, wherein the surface line velocity of the rapid-quenching device is 10-60 m/s.

10. An apparatus for manufacturing melt-spinning alloys, including a furnace body (1), a melting device and a rapid-quenching device (11), wherein the furnace body (1) has two chambers, a first chamber and a second chamber, which can control the pressure respectively, the melting device is arranged in the first chamber, and the rapid-quenching device is arranged in the second chamber.

11. The apparatus according to claim 10, wherein the inner chamber of the furnace body (1) is divided into an upper chamber and a lower chamber by a clapboard, the first chamber is the upper chamber, and the second chamber is the lower chamber.

12. The apparatus according to claim 10, wherein the first chamber and the second chamber are respectively provided with a pressure adjusting system for regulating the inside pressure of the chamber.

13. The apparatus according to claim 12, wherein the pressure adjusting system includes a pressure control system (15) and/or a vacuum system (17).

14. The apparatus according to claim 10, wherein the melting device includes a tundish (7), a nozzle extending to the second chamber is arranged on the bottom of the tundish (7), and at least one opening (18) is arrange on the nozzle.

15. The apparatus according to claim 14, wherein the number of openings (18) is 1-20.

16. The apparatus according to claim 15, wherein the cross-sectional area of the openings (18) is 0.03-10 mm².

17. The apparatus according to claim 10, wherein the rapid-quenching device (11) includes a rotatable cooling roller or cooling pan; and the width of the cooling roller or the diameter of the cooling pan is 5-800 mm.

18. The apparatus according to claim 17, wherein the width of the cooling roller or the diameter of the cooling pan is 10-500 mm.

19. The apparatus according to claim 10, wherein a pressure monitoring device (13) for monitoring the inside pressure is respectively arranged inside the first chamber and the second chamber.

20. The apparatus according to claim 11, wherein a pressure monitoring device (13) for monitoring the inside pressure is respectively arranged inside the first chamber and the second chamber.
